(19) United States
(12) Patent Application Publication
(10) Pub. No.: US 2005/0066193 A1
(43) Pub. Date: Mar. 24, 2005

(54) Selectively responding to intrusions by computers evaluating intrusion notices based on local intrusion detection system policy

(76) Inventor: Linwood Hugh Overby JR., Raleigh, NC (US)

Correspondence Address: David K. Purks;Myers Bigel Sibley & Sajovec, P.A., P.O. Box 37428, Raleigh, NC, 27627, US

(21) Appl. No.: 10/667,804

(22) Filed: Sep. 22, 2003

(51) Int. Cl. G06F 11/30

(52) U.S. Cl. 713/201

(57) ABSTRACT

A computer selectively responds to at least one notification of an intrusion from a network-accessible intrusion detection service (IDS) manager. The computer selectively responds to the intrusion notification based on local IDS policy that includes information related to the computer. The information related to the computer may be based on whether the computer is a server of information for other computers in the computer system, whether the computer is protected by a firewall from a source of the intrusion, proximity of the computer to a source of the intrusion, memory utilization in the computer, and/or processor utilization in the computer.

### FIELD OF THE INVENTION

This invention relates generally to computer security and, more particularly, to responding to computer intrusions that violate computer security policies.

### BACKGROUND OF THE INVENTION

In the computer security field, “intrusion” is a broad term encompassing many undesirable activities. The objective of an intrusion may be to acquire information that a person is not authorized to have (referred to as “information theft”), it may be to cause business harm by rendering a network, system, or application unusable (referred to as “denial of service”) and/or, it may be to gain unauthorized use of a system as a stepping stone for further intrusions elsewhere. Intrusions can follow a pattern of information gathering, attempted access, and then destructive attacks.

Some intrusions can be detected and neutralized by the target system, although often not in real time. Other intrusions may not be effectively neutralized by the target system. Intrusions can also make use of “spoofed” packets which are not easily traceable to their true origin. Many intrusions now make use of unwitting accomplices—that is, machines or networks that are used without authorization to hide the identity of the intruder. For these reasons, detecting attempts at information gathering, access attempts, and intrusion accomplice behaviors can be an important part of intrusion detection.

As illustrated in FIG. 1, intrusions can be initiated against a host 100 on an internal network 115 by, for example, an intruder 130 that is on an external network 135 (e.g., internet), or from an intruder 110 that is on the internal network 115. A firewall 120 may provide some protection against intrusions from external networks. However, it may not prevent intrusions once the firewall has “approved” entry into the internal network 115, and it may not provide protection when the intrusion is initiated from inside the internal network 115 (e.g., intruder 110). In addition, end-to-end encryption can limit the types of intrusions that can be detected by an intermediate device, such as the firewall 120, because the intermediate device may be unable to evaluate the packets in an unencrypted form for evidence of an intrusion.

An Intrusion Detection System (hereinafter, “IDS”) can provide detection of many types of intrusions. Referring to FIG. 2, an IDS may include sniffers that examine network traffic. Sniffers may be placed at strategic points in networks, such as shown by a sniffer 210 in front of the firewall 220; by a sniffer 230 behind the firewall 220; by a sniffer 240 on the internal network 115; and/or by a sniffer 250 between a host 260 and the internal network 115. Sniffers may use “pattern matching” to try to match communicated information against a known intrusion signature. Performing pattern matching on all network traffic can require significant processing time, and may result in a backlog of traffic to be analyzed and a resulting delay in identifying an intrusion. Growth in the number of known intrusion signatures can increase the processing time and associated delay in identifying an intrusion.

Upon detecting an intrusion, a sniffer may alert an IDS management system 270, which may take action to stop an intrusion. For example, sniffers 230 and 250 have been illustrated as communicating “alerts” to the IDS management system 270. The IDS management system 270 may be, for example, IBM's Tivoli Risk Manager system. The IDS management system 270 may correlate intrusion notices from several sniffers to determine whether an intrusion has occurred and, if so, characteristics of the intrusion. The IDS management system 270 may download communication filter rules to the firewall 220 responsive to an intrusion.

Sniffers may also, or may alternatively, notify a service, such as IBM's Emergency Response Services (ERS) unit 200, which provides logging and analysis of security alerts that are detected by IDS components. In the illustrated example, the sniffer 210 before the firewall 220 sends alerts to the Emergency Response Services unit 200.

### SUMMARY OF THE INVENTION

In some embodiments of the present invention, a computer selectively responds to at least one notification from a network-accessible intrusion detection service (IDS) manager of an intrusion by evaluating the notification based on local IDS policy that includes information that is related to the computer. The information related to the computer may be based on, for example, whether the computer is a server of information for other computers in the computer system, whether the computer is protected by a firewall from a source of the intrusion, proximity of the computer to a source of the intrusion, memory utilization in the computer, and/or processor utilization in the computer.

The local IDS policy may be downloaded from a network-accessible repository to the computer. The IDS policy may include one or more response actions to be taken based on an intrusion notification from the IDS manager. A response action by the computer may include terminating an application that is a target of the intrusion, discarding information in a communication, and/or discontinuing communication with a source of the communication.

Accordingly, the IDS manager may notify a computer that an intrusion has been detected. The computer may then decide whether and/or how it will respond to the notice based on local policies and information relating to the computer. Thus, in a computer system that has numerous computers, each computer may respond differently to an intrusion notice based on local information that is know to each computer. In this way, how local computers respond to intrusions may be individually customized. Such local customization of responses may enable improved automation of how a computer system responds to intrusions.

### BRIEF DESCRIPTION OF THE DRAWINGS

FIG. 1 is a block diagram of a computer networking system according to the prior art that is subject to security intrusions.

FIG. 2 is a block diagram of a computer networking system with intrusion detection components according to the prior art.

FIG. 3 is a block diagram of a computer networking system with intrusion detection components according to various embodiments of the present invention.

FIG. 4 is a block diagram of a host computer with an intrusion detection service enabled application according to various embodiments of the present invention.

FIG. 5 is a flowchart that illustrates operations for selectively responding to intrusions according to various embodiments of the present invention.

FIG. 6 is a block diagram of a computer system according to embodiments of the present invention.

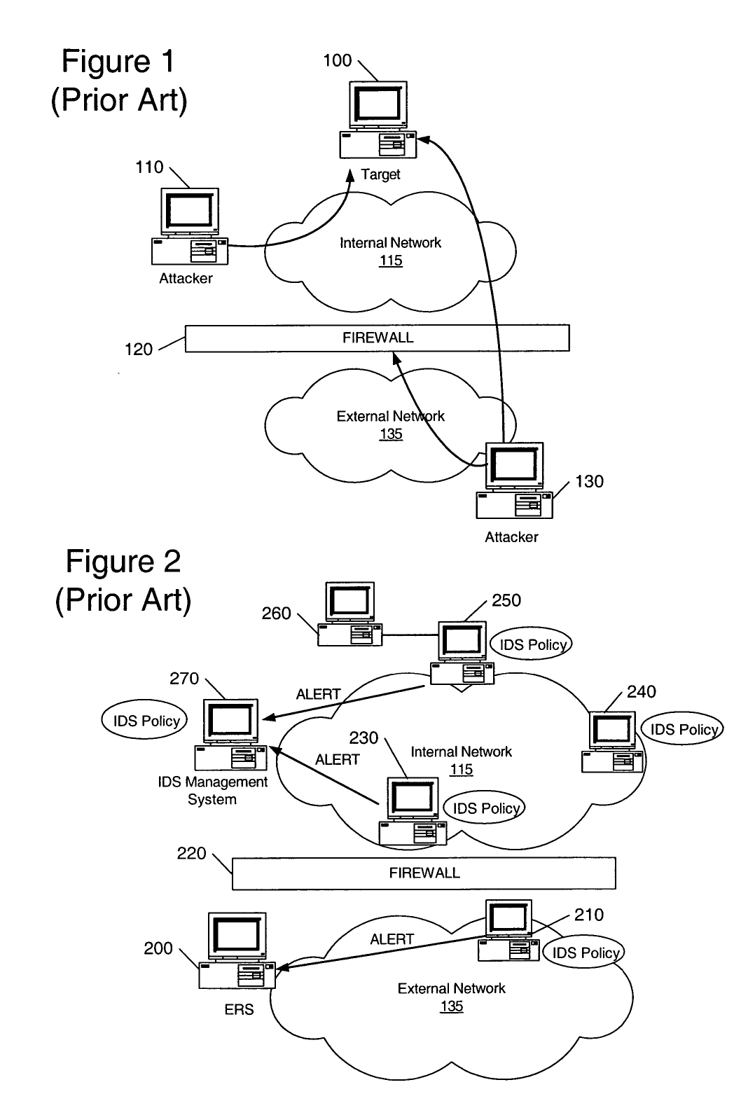

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numerals refer to like elements throughout.

As will be appreciated by one of skill in the art, the present invention may be embodied as methods, systems, and/or computer program products. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user computer, partly on the user computer, as a stand-alone software package, partly on the user's computer and partly on a remote computer or entirely on the remote computer. In the latter scenario, the remote computer may be connected to the user's computer through, for example, a local area network (LAN) or a wide area network (WAN), or the connection may be made through an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

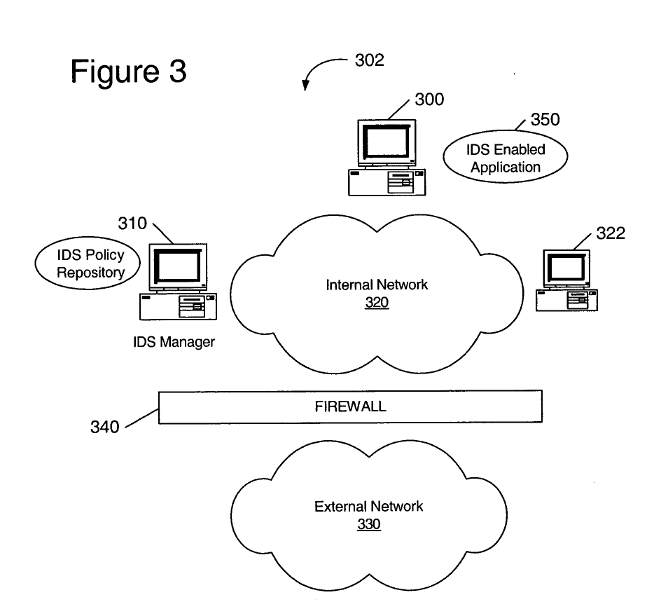

FIG. 3 illustrates a computer networking system 302 with intrusion detection components according to various embodiments of the present invention. The computer networking system 302 includes at least one host computer 300 and an IDS manager 310 that are connected by an internal network 320. The computer networking system 302 may also include one or more sensors 322 that are configured to sense events that may indicate one or more possible intrusions in the computer networking system 302, and to report the events to the IDS manager 310. The internal network 320 is connected to an external network 330 (such as the Internet) through a firewall 340. The computer networking system 302 may include other components such as, for example, additional host computers and/or additional IDS components.

The IDS manager 310 maintains an IDS policy for the system, thereby forming an IDS policy repository. A local IDS policy may be downloaded from the IDS policy repository to the host computer 300. The local IDS policy may include one or more response actions that may be taken based on an intrusion notification from the IDS manager 310 and information that is known to the host computer 300. A response action by the host computer 300 may include terminating an application that is a target of an intrusion, discarding information in a communication, and/or discontinuing communication with a source of the communication.

The IDS manager 310 determines whether an intrusion into one or more components of the computer networking system 302 has occurred. For example, the IDS manager 310 may use pattern matching to match information that is communicated through the internal network 320 against known intrusion signatures, and/or may correlate events that are reported from the sensor 322 and/or other components in the computer networking system 302 to determine whether an intrusion has occurred. When an intrusion has been determined to have occurred, the IDS manager 310 informs the host computer 300, and may inform other host computers and/or other components in the computer networking system 302. The host computer 300 then decides whether and/or how it will respond to the intrusion notice from the IDS manager 310 based on a local IDS policy that includes information that is related to the computer.

The information related to the host computer 300 may be based on whether the host computer 300 is a server of information for other components in the computer networking system 302, whether the host computer 300 is protected by the firewall 340 from a source of the intrusion, proximity of the host computer 300 to a source of the intrusion, memory utilization in the host computer 300, and/or processor utilization in the host computer 300.

Accordingly, the host computer 300 decides whether and/or how it will respond to an intrusion notice based on local policies that include information relating to the computer. Thus, in a computer networking system 302 that has numerous host computers 300, each host computer 300 may respond differently to an intrusion notice based on local information that is know to that host computer 300. In this way, how host computers 300 respond to intrusions can be individually customized. Such local customization of responses may enable improved automation of how host computers 300 respond to intrusions.

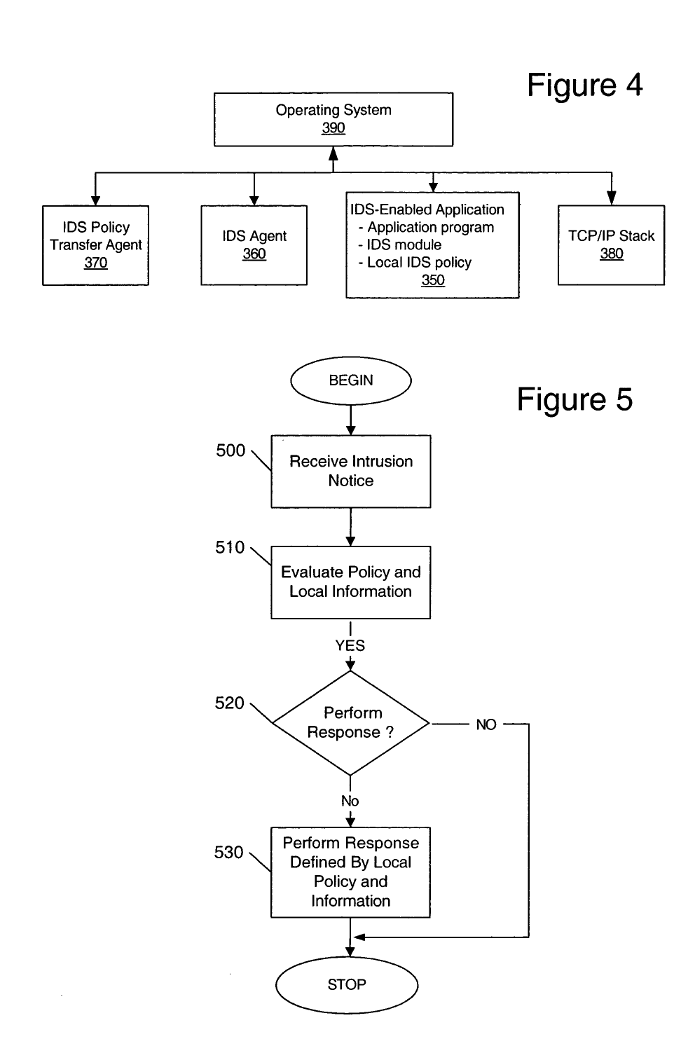

The host computer 300 may include at least one IDS-enabled application 350 that is configured to respond based on an intrusion notification from the IDS manager 310. Referring to FIG. 4, the host computer 300 may execute the one or more IDS-enabled applications 350, an IDS agent 360, an IDS policy transfer agent 370, network programs, such as a TCP/IP stack 380, and an operating system 390 that manages communication among the applications, network programs, and agents. The IDS-enabled application 350 may include an application program, an IDS module, and a local IDS policy, and one or more of which may be allocated to the same, or different, logical memory space during the execution of the application program. The application program may also provide application functionality to, for example, an operator of the host, which is unrelated to detection of intrusions, and, as described below, the application program may also use the local IDS policy to take actions based on an intrusion notice and information that is known to the host computer 300.

The local IDS policy in the IDS-enabled applications 350 may be downloaded from the IDS manger 310, which may allow more uniform treatment of intrusion detection among hosts in the system. For example, the IDS-enabled application 350 may become initialized with a local IDS policy by the application program calling the IDS module with an initialization request. The IDS module may cause the IDS policy transfer agent 370 to read an IDS policy that may be specifically configured for the IDS-enabled application 350 from the IDS manger 310, and to allocate the retrieved IDS policy to the local memory space of the application program. For various reasons, such as security, the application program should be provided only with relevant IDS policies of which it has been authorized to receive. The IDS policy transfer agent 370 may check the authorization of the application to view an IDS policy before placing the retrieved IDS policy in the memory space of the application. The IDS policy transfer agent 370 may then provide the IDS-enabled application 350 with a handle (or pointer) to the retrieved IDS policy within the application memory space and/or the IDS agent 360.

Based on an intrusion notice from the IDS manager 310, the application program may use the IDS module to retrieve appropriate actions from the local IDS policy that may be taken by the application and/or the IDS agent 360 to stop, and possibly remedy, the effect of an intrusion. FIG. 5 shows operations that may be performed to evaluate and respond to an intrusion notice. At block 500, the IDS agent 360 receives an intrusion notice from the IDS manager 310. At block 510, the IDS agent 360 evaluates the intrusion notice based on the local IDS policy and information related to the host computer 300. The evaluation may include evaluating whether the host computer 300 is a server of information for other components in the computer networking system 302 (e.g., webserver, intranet application server, backend server), whether the host computer 300 is a firewall for other components in the computer networking system 302, whether the host computer 300 is protected by the firewall 340 from a source of the intrusion, proximity of the host computer 300 to a source of the intrusion, memory utilization in the host computer 300, and/or processor utilization in the host computer 300.

At Block 520, a decision is made whether the IDS agent 360 and/or by the IDS enabled application 350 are to take an action responsive to the intrusion notice. When a response action is to be taken, then at Block 530, the response action that may be taken by the IDS agent 360 and/or by the IDS enabled application 350 may include, but not be limited to, terminating an application that is a target of an intrusion, discarding information in a communication, and/or discontinuing communication with a source of the communication (e.g., breaking the connection with the source and/or closing an interface socket).

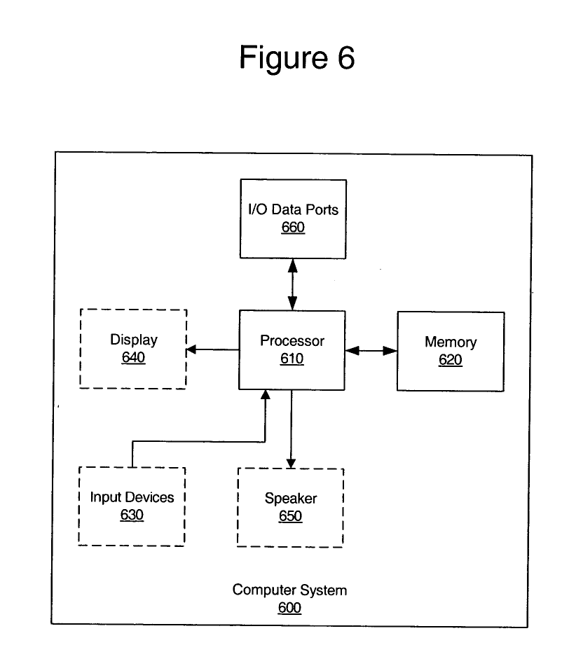

FIG. 6 illustrates an exemplary embodiment of a host computer system 600 suitable for executing one or more IDS-enabled applications, an IDS agent, an IDS policy transfer agent, network programs, and an operating system, for example as shown in FIG. 4, in accordance with some embodiments of the present invention. The computer system 600 typically includes a processor 610 that communicates with a memory 620. The computer system 600 may, optionally, include input device(s) 630 such as a keyboard or keypad, and a display 640 (illustrated in dashed lines) that also communicate with the processor 610. The computer system 600 may further include optional devices such as a speaker 650, and an I/O data port(s) 660 that also communicate with the processor 610. The I/O data ports 660 can be used to transfer information between the computer system 600 and another computer system or a network. These components may be conventional components such as those used in many conventional computer systems which may be configured to operate as described herein.

The processor 610 can be any commercially available or custom microprocessor. The memory 620 is representative of the overall hierarchy of memory devices containing the software and data used to implement the functionality of the computer system 600. The memory 620 can include, but is not limited to, the following types of devices: cache, ROM, PROM, EPROM, EEPROM, flash memory, SRAM, and DRAM. The memory 620 may include several categories of software and data used in the computer system 600: an operating system; application programs; input/output (I/O) device drivers; and data. As will be appreciated by those of skill in the art, the operating system may be any operating system suitable for use with a computer system, such as OS/2, AIX or System390 from International Business Machines Corporation, Armonk, N.Y., Windows95, Windows98, Windows2000, Windows NT, Windows ME, Windows XP from Microsoft Corporation, Redmond, Wash., Unix or Linux. The I/O device drivers typically include software routines accessed through the operating system by the application programs to communicate with devices such as the I/O data port(s) 660 and certain memory 620 components. The application programs are illustrative of the programs that implement the various features of the data processing system 600 and preferably include at least one application which supports operations according to embodiments of the present invention. Finally, the data represents the static and dynamic data used by the application programs, the operating system, the I/O device drivers 660, and other software programs that may reside in the memory 620.

In the drawings and specification, there have been disclosed embodiments of the invention and, although specific terms are employed, they are used in a generic and descriptive sense only and not for purposes of limitation, the scope of the invention being set forth in the following claims.

1. A method of responding to an intrusion, the method comprising:
selectively responding to at least one notification of an intrusion, from a network-accessible intrusion detection service (IDS) manager, by a computer evaluating the notification based on local IDS policy that includes information relating to the notification of an intrusion and information related to the computer.

2. The method of claim 1, wherein the information related to the computer is based on whether the computer is a firewall for other computers in the computer system.

3. The method of claim 1, wherein the information related to the computer is based on whether the computer is a server of information for other computers in the computer system.

4. The method of claim 3, further comprising evaluating whether the computer serves as at least one of a webserver, an intranet application server, and a backend server.

5. The method of claim 1, wherein the information related to the computer is based on whether the computer is protected by a firewall from a source of the intrusion.

6. The method of claim 1, wherein the information related to the computer is based on memory utilization in the computer.

7. The method of claim 1, wherein the information related to the computer is based on processor utilization in the computer.

8. The method of claim 1, wherein the information related to the computer is based on information from other than the IDS manager that indicates an intrusion into the computer.

9. The method of claim 1, wherein the information related to the computer is based on proximity of the computer to a source of the intrusion.

10. The method of claim 1, further comprising downloading the local IDS policy from a network-accessible repository to the computer.

11. The method of claim 1, wherein the local IDS policy comprises one or more response actions to be taken based on a notification from the network-accessible IDS manager of an intrusion.

12. The method of claim 11, wherein the response action comprises terminating an application that is a target of an attack.

13. The method of claim 11, wherein the response action comprises discarding information in a communication to the computer.

14. The method of claim 11, wherein the response action comprises discontinuing communication with a source of the communication.

15. A computer system that responds to intrusions, the computer system comprising:
a plurality of computers, each comprising a local IDS policy;
an intrusion detection service (IDS) manager that is configured to generate for the computers at least one notification of an intrusion, and wherein each of the computers is configured to selectively respond to the notification based on the local IDS policy and information relating to the computer.

16. The computer system of claim 15, wherein the IDS manager is configured to determine that an intrusion has occurred in the computer system, and is configured to generate a notification based on determining that an intrusion has occurred.

17. The computer system of claim 16, wherein at least two of the computers respond differently to the same intrusion notification from the IDS manager.

18. The computer system of claim 16, wherein at least one of the computers responds differently to the same intrusion notification repeated at least once over time.

19. The computer system of claim 15, further comprising a plurality of sensors that are configured to sense events that may indicate one or more possible intrusions into the computer system, and that are configured to inform the IDS manager of the events, and wherein the IDS manager is configured to determine that an intrusion has occurred in the computer system by correlating the events from the sensors.

20. The computer system of claim 15, wherein the computers are configured to download the local IDS policy from a policy repository.

21. The computer system of claim 15, wherein at least one of the computers is configured to selectively respond to the notification based on the local IDS policy and whether the computer is a server of information for other computers in the computer system.

22. The computer system of claim 15, wherein at least one of the computers is configured to selectively respond to the notification based on the local IDS policy and whether the computer is protected by a firewall from a source of the intrusion.

23. The computer system of claim 15, wherein at least one of the computers is configured to selectively respond to the notification based on the local IDS policy and based on at least one of memory utilization in the computer and processor utilization in the computer.

24. The computer system of claim 15, wherein at least one of the computers is configured to selectively respond to the notification based on the local IDS policy and information relating to possible intrusions into the computer.

25. The computer system of claim 15, wherein at least one of the computers is configured to selectively respond to the notification based on the local IDS policy and information relating to proximity of the computer to a source of the intrusion.

26. A computer program product for responding to an intrusion, the computer program product comprising program code embodied in a computer-readable storage medium, the computer program code comprising:
program code that is configured to selectively respond to at least one notification from a network-accessible intrusion detection service (IDS) manager of an intrusion based on local IDS policy and information relating to a computer.

27. The computer program product according to claim 26, further comprising program code that is configured to download the local IDS policy from a network-accessible repository to the computer.

28. The computer program product according to claim 26, further comprising program code that is configured to perform one or more response actions based on the notification, the local IDS policy, and the information relating to the computer.

29. The computer program product according to claim 26, further comprising program code that is configured to selectively respond to the notification based on whether the computer is a server of information for other computers in the computer system.

30. The computer program product according to claim 26, further comprising program code that is configured to selectively respond to the notification based on at least one of whether the computer is protected by a firewall from a source of the intrusion and proximity of the computer to a source of the intrusion.

31. The computer program product according to claim 26, further comprising program code that is configured to selectively respond to the notification based on at least one of memory utilization in the computer and processor utilization in the computer.
